(19) United States
(12) Patent Application Publication
(10) Pub. No.: US 2006/0174751 A1
(43) Pub. Date: Aug. 10, 2006

(54) Pivotal mechanism of a swinging structure of a cymbal pedal

(76) Inventor: Tsun-Chi Liao, Taichung City (TW)

Correspondence Address: BIRCH STEWART KOLASCH & BIRCH, PO BOX 747, FALLS CHURCH, VA, 22040-0747, US

(21) Appl. No.: 11/052,917

(22) Filed: Feb. 9, 2005

(51) Int. Cl. G10D 13/02

(52) U.S. Cl. 84/422.1

(57) ABSTRACT

A pivotal mechanism of the swinging structure of cymbal pedal comprises a moving element, the upper portion of the moving element having a pair of mounting plates, the front end of the mounting plate connected to the front end of a pedal stand through a first chain, the back end of the pedal stand pivotally connected to a pedal, the front end of the pedal having a second chain and the second chain again connected to the back end of the moving element, the mounting plate of the moving element pivotally connected to a suspension element, the top of the suspension element connected to a coupling rod at the interior of a cymbal stand, a guiding wheel located below the suspension element which allows the moving element to swing, and through the connection of a bearing on a shaft resulting the pedal to be depressed smoothly.

### FIELD OF THE INVENTION

The present invention relates to a pivotal mechanism of a swinging structure of a cymbal pedal, and more particularly to a cymbal transmission structure that controls the upper cymbal to strike the lower cymbal in making a sound when the pedal is depressed, and through the pivotal mechanism between the pedal and the transmission rod inside the cymbal stand, the depressing movement can more smoothly and the melody produced can be more accurate.

### BACKGROUND OF THE INVENTION

In a common large-scale orchestra, the operator of the musical instrument apart from using their hands to strike the big and small drums, he or she also needs to use his or her foot to step on the cymbal pedal according to the music rhythm at the same time, causing the upper cymbal to strike the lower cymbal in making a sound. Obviously, the operator must give dual attention to musical instrument of the many kinds of not unison effect at the same time, thus causing the secondary control mechanism of each kind of musical instrument to appear extremely important, especially the mechanism that using foot to step on the pedal in order to control the upper and lower cymbals to strike each other, the sensitivity and the smooth feeling in operating such mechanism will directly affect the accuracy of the musical rhythm and the comfort of the operator. There are many kinds of linking mechanism connecting the pedal and the interior transmission rod of the cymbal stand in the market, but they are still not ideal in actual operation.

FIGS. 1A and 1B show the conventional transmission structure of cymbals, the transmission structure mainly includes a pedal stand 1 having a three-legs base frame 2, a cymbal stand 3 allows a transmission rod 4 to run through, such transmission rod 4 is connected to the upper cymbal, a connecting rod 5 is pivoted to the lower part of the transmission rod 4, and the bottom part of the connecting rod 5 links to a pedal 6. When a user steps on the pedal 6, the connecting rod 5 will pull the transmission rod 4 downwards, causing the upper cymbal to move down and strike on the lower cymbal in order to make the appropriate sound. However, when the user steps on the pedal 6, since the end portion of the pedal 6 is a rotating pivotal point, which means the pivotal point of the connecting rod 5 and the place on the pedal 6 where to put the tip of the toes is an arc-shaped displacement path, but the transmission from the transmission rod 4 of the cymbal actually needs a vertically straight movement. Although there is a connecting rod 5 pivoted between the pedal 6 and the transmission rod 4 to provide a slightly deflected movement, different stress direction during operation will still cause the transmission rod 4 to deflect, and the transmission rod 4 cannot deflect so much since it is restricted by the cymbal stand 3. The main point is that the transmission rod 4 pulls the upper cymbal up and down in an oblique movement causing one side of the upper cymbal to strike the lower cymbal faster than the other side, resulting in a production of noisy cracked sound and causing variation in pitches from the proper tone of the entire melody.

### SUMMARY OF THE INVENTION

It is a primary object of the present invention to provide a pivotal mechanism of the swinging structure of cymbal pedal comprises a moving element, the upper portion of the moving element having a pair of mounting plates, the front end of the mounting plate is connected to the front end of a pedal stand through a first chain, the back end of the pedal stand is pivotally connected to a pedal, the front end of the pedal having a second chain and the second chain is again connected to the back end of the moving element, the mounting plate of the moving element is pivotally connected to a suspension element, the top of the suspension element is connected to a coupling rod at the interior of a cymbal stand, a guiding wheel is located below the suspension element which allow the moving element to swing, and through the connection of a bearing on a shaft, causing the pedal to be depressed smoothly.

The foregoing, as well as additional objects, features and advantages of the invention will be more readily apparent from the following detailed description, which proceeds with reference to the accompanying drawings.

### BRIEF DESCRIPTION OF THE DRAWINGS

FIGS. 1A and 1B are perspective views of a conventional cymbal transmission structure.

FIG. 2 is a perspective exploded view of the preferred embodiment of the present invention.

FIG. 3 is a perspective view of the preferred embodiment of the present invention after assembly.

FIG. 4A is a sectional view of the preferred embodiment of the present invention.

FIG. 4B is a perspective view of FIG. 4A in movement.

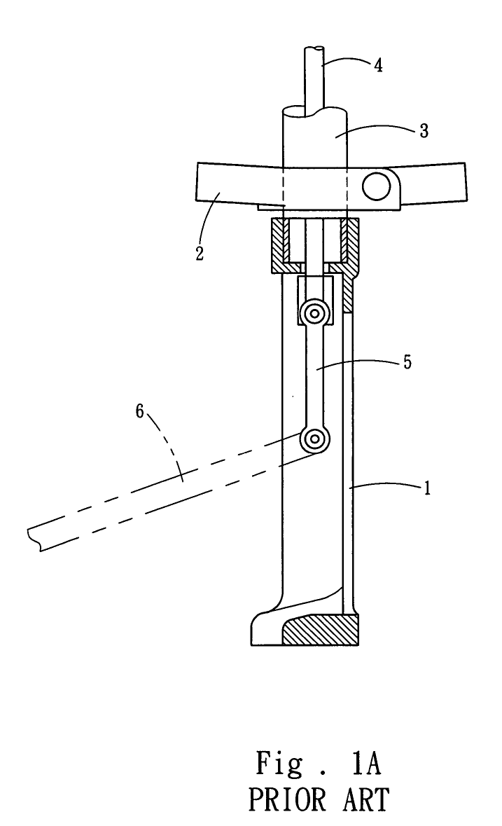

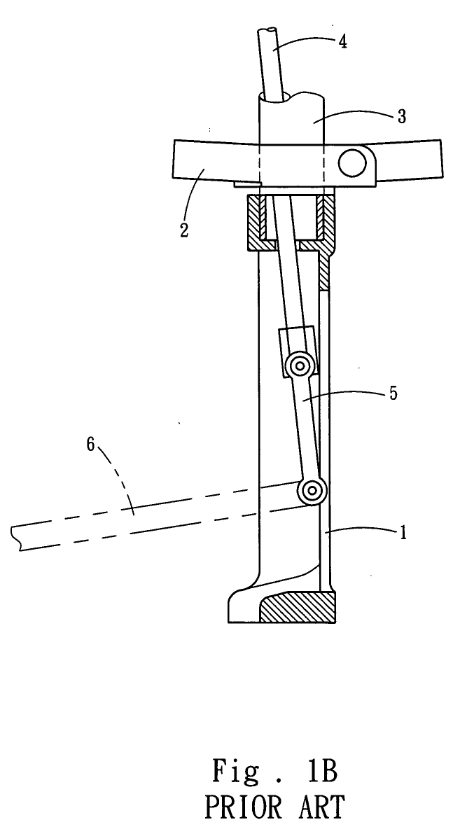

### DETAILED DESCRIPTION OF THE PREFERRED EMBODIMENTS

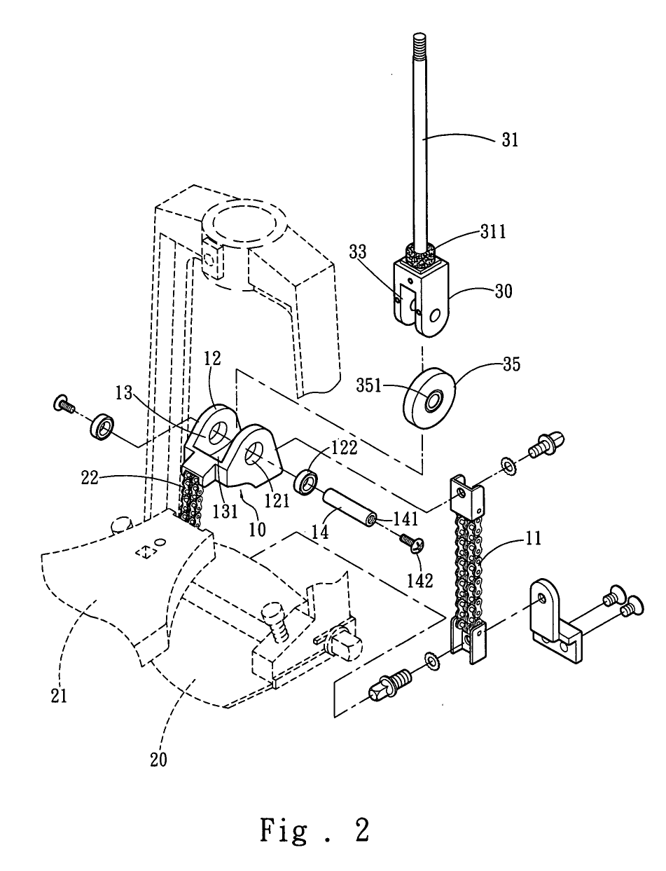

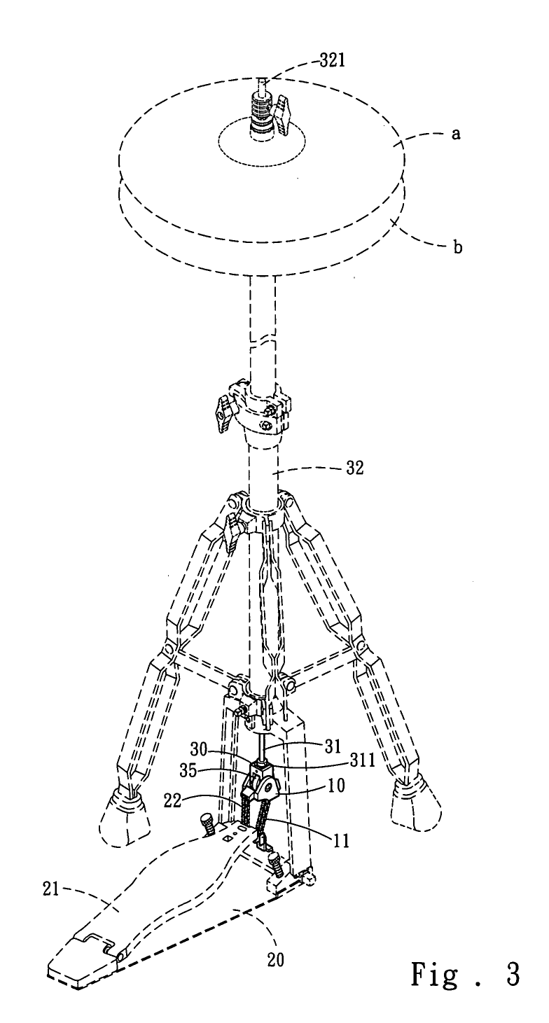

Please refers to FIGS. 2 and 3, which show the pivotal mechanism of a swinging structure of a cymbal pedal, include:

A moving element 10, having its front connects to the upper extreme of a first chain 11, the first chain 11 having its lower extreme links to a pedal stand 20, the two corresponding side of the upper portion of the moving element 10 having a pair of mounting plates 12. A housing space 13 is formed between the two corresponding mounting plates 12, a hole 121 is formed on each mounting plate 12, a bearing 122 is to be inserted to the hole 121, a shaft 14 runs through the center of the bearing 122.

The back portion of the pedal stand 20 is pivoted to a pedal 21, the front end of the pedal 21 fastens to the lower end of a second chain 22, the upper end of the second chain 22 is connected to the back portion of the moving element 10.

A suspension element 30 having a coupling rod 31 at its head portion, the upper end of the coupling rod 31 is threaded for screwing onto the lower portion of a transmission rod 321 which is located at the interior of a cymbal stand 32. A vibration absorbing means 311 can be put on the coupling rod 31. The lower portion of the suspension element 30 having a pair of arch-shaped clamps 33, the arch-shaped clamps 33 are used to be inserted into the housing space 13 between the two corresponding mounting plates 12. A guiding wheel 35 having a bearing 351 at the center is located between the pair of clamps 33. A shaft 14 runs through the center of the bearing 351. The bottom of the housing space 13 of the moving element 10 is a concave arch-shaped guiding surface 131. The guiding surface 131 can slip and rotate along the guiding wheel 35. Each of the two ends of the shaft 14 having a screw hole 141 to be fastened by a bolt 142.

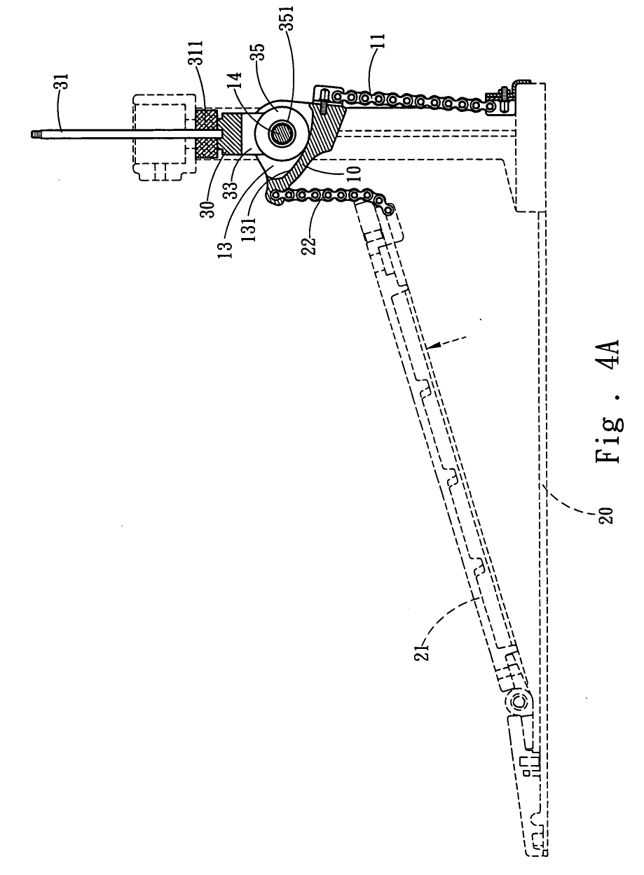

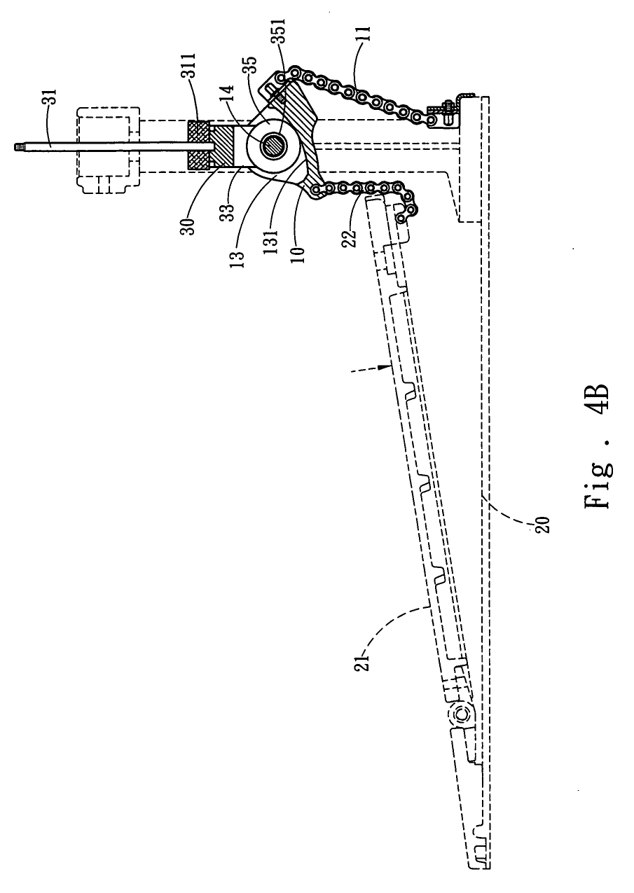

According to the above structure, please refer to FIGS. 4A and 4B. When the pedal 21 is depressed by a user's foot, the force of the toes will cause the second chain 22 to pull down the moving element 10, the first chain 11 will be hung by the moving element 10 at the same time. Since the moving element 10 is pivoted to the suspension element 30, the movement of the moving element 10 will cause the transmission rod 321 inside the cymbal stand 32 to pulled down, thus allowing the upper cymbal a to move downward striking the lower cymbal b to make a sound (as shown in FIG. 3). Although the foot toes are exerting an arc-shaped downward force to the pedal 21 when the pedal 21 is depressed, the moving element 10 and the suspension element 30 are pivoted together by the shaft 14, and the clamps 33 of the suspension element 30 are pivoting a guiding wheel 35. Thus the suspension element 30 will carry the transmission rod 321 to pull downward together. The guiding surface 131 of the housing space 13 of the moving element 10 can oscillate freely along the guiding wheel 35, allowing the transmission rod 321 inside the cymbal stand 32 to have vertically straight movement. And the bearing 122 between the pair of mounting plates 12 can allow the moving element 10 to oscillate smoothly when the pedal 21 is depressed. The bearing 351 inside the guiding wheel 35 also enable the guiding wheel 35 to rotate freely on the shaft 14.

It is worthwhile to mention that the front and rear portion of the moving element 10 is connected to the first chain 11 and the second chain 22 respectively. The moving element 10 is pivoted to the suspension element 30, and the moving element 10 can be hung up by the coupling rod 31 which is located above the suspension element 30. The first chain 11 and the second chain 22 are elastic linking elements. When the pedal 21 is depressed, the second chain 22 pulls down the rear end of the moving element 10, while the front end of the moving element 10 draws the first chain 11 upward; the first chain 11 can move elastically and be hung up along the direction of the pulling force (as shown in FIG. 4B). When the pedal 21 is released, the restoring force of the spring (not shown) inside the cymbal stand 32 causes the transmission rod 321 to pull up the suspension element 30 and draws the second chain 22 upwards, and the first chain 11 is then moved back to its original status (as shown in FIG. 4A). According to the above phenomena, the transmission rod 321 inside the cymbal stand 32 can be vertically pulled upwards and downwards permanently.

In summary, the present invention has been manufactured to be samples according to the content of the specification and the drawings, and it is proved to achieve the anticipated goal and effect due to numbers of successful experimental operation. The present invention can sufficiently solve the defect of the conventional cymbal transmission structure, which disallows the transmission rod 4 to move vertically straight up and down, causing one side of the upper cymbal to strike the lower cymbal faster than the other sides, which produces noisy cracked sound. Although the invention has been explained in relation to its preferred embodiment, it is not used to limit the invention. It is to be understood that many other possible modifications and variations can be made by those skilled in the art without departing from the spirit and scope of the invention as hereinafter claimed.

What is claimed is:

1. A pivotal mechanism of a swinging structure of a cymbal pedal comprising:
a moving element, having its front and back connects to a first chain and a second chain respectively, and wherein said first chain is connected to the front end of a pedal stand, said second chain is connected to the front end of a pedal, the back end of the pedal is pivotally connected to a pedal stand, the upper portion of the moving element has a pair of mounting plates, and a housing space is formed between the two corresponding mounting plates; and
a suspension element located within said housing space, the top of the suspension element connected to a coupling rod which is located at the interior of a cymbal stand, and a shaft running through the suspension element and the mounting plate of the moving element.

2. The pivotal mechanism of a swinging structure of a cymbal pedal according to claim 1, wherein the lower portion of the suspension element has a pair of arch shaped clamps, a guiding wheel has a bearing at the center located between the pair of clamps, and the bottom of the housing space of the moving element is a concave arch-shaped guiding surface to allow the guiding surface to slip and rotate along the guiding wheel.

3. The pivotal mechanism of a swinging structure of a cymbal pedal according to claim 1, wherein the pair of mounting plates has a hole at each side, a bearing is inserted into the hole, and a shaft runs through the center of the bearing.

4. The pivotal mechanism of a swinging structure of a cymbal pedal according to claim 1, wherein the suspension element has a coupling rod at its head portion, the upper end of the coupling rod is threaded for screwing onto a transmission rod at the interior of a cymbal stand, and a vibration absorbing means can be connected to the coupling rod.
